(19) United States
(12) Patent Application Publication
(10) Pub. No.: US 2009/0300351 A1
(43) Pub. Date: Dec. 3, 2009

(54) FAST SEARCHABLE ENCRYPTION METHOD

(75) Inventors: Hao Lei, Beijing (CN); Ye Tian, Beijing (CN); Ke Zeng, Beijing (CN); Liming Wang, Beijing (CN); Toshikaza Fukushima, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 12/474,785

(22) Filed: May 29, 2009

(30) Foreign Application Priority Data
May 30, 2008 (CN) 200810098359.1
Aug. 1, 2008 (CN) 200810145083.8

(51) Int. Cl. H04L 9/00; G06F 17/30; H04L 9/08

(52) U.S. Cl. 713/165; 707/5; 380/44; 380/277; 707/E17.014; 707/E17.032

(57) ABSTRACT

The present invention provides a method, apparatus and system for fast searchable encryption. The data owner encrypts files and stores the ciphertext to the server. The data owner generates an encrypted index according to each keyword of the files, and stores the encrypted index to the server. The index is composed of keyword item sets each being identified by a keyword item set locator and containing at least one or more file locators of the files associated with the corresponding keyword. Each file locator contains ciphertext of information for retrieval of an encrypted file and only with the correct file locator decryption key can the ciphertext be decrypted. Data owner issues a keyword item set locator as well as file locator decryption key to a searcher to enable the searcher to search on the encrypted index and retrieve files related to a certain keyword.

### FIELD OF THE INVENTION

The invention relates generally to information retrieval techniques, and more particularly to a method, apparatus and system for fast searchable encryption.

### BACKGROUND

With wide use of network and communication technique, data storage and management services become popular. In some situations, user stores some, even massive, data on a remote server(s) maintained by a third party storage vendor for various reasons, for example, limited storage capacity at the user's terminal, incapability of providing stable or long time continuous access of data at the user's terminal, cost of data maintenance in view of that the cost of storage management is generally 5-10 times higher than the cost of initial acquisition of data, and so on.

However, most third party storage vendors do not provide strong assurances of data confidentiality and integrity. If sensitive data is being stored on a storage server maintained by a semi-trusted third party, a security system is needed to offer assurances of data confidentiality and access pattern privacy.

FIG. 1 illustrates a scenario in which Alice, a data owner, outsources her files to a semi-trusted third party, namely the storage service provider, and she still intends to share some files with specific searchers, e.g. her friends, colleagues, and/or relatives. In other words, she would like to let the searchers search directly her files on the storage service, instead of issue queries to Alice herself. On the other hand, Alice wants to define and enforce access rights on the shared files. In the example shown in FIG. 1, Alice would like to make the files Novel.pdf, Pets.jpg and Financial.doc searchable and accessible by her relatives, but other files blind to her relatives. Similarly, Alice would like to make some files searchable and accessible by her friends and colleagues respectively, but other files not. To archive this goal, data security and access control measures are needed.

Since the storage service provider is semi-trusted, it is required that Alice's files are all encrypted and the storage service provider cannot disseminate file decryption keys to the searchers. Furthermore, Alice may not rely on the storage service provider to enforce access control on her files.

In view of the above situation, there are following challenges: how to enable the searchers to search and further access the files; how to disseminate file decryption keys to the searchers; how to distinguish different file access rights with respect to different searchers; how to maintain the service if a file is updated or removed; and how to make the solution efficient in terms of computation and communication consumption.

The ability to search easily and efficiently within remote data is a very important feature. Some efficient content-based keyword search indexing schemes exist up to date. However, supporting content-based search with privacy in a secure remote storage is difficult, and often tends to compromise either security or performance significantly. For example, if data is stored in an encrypted form on a remote server, to perform content-based search, one cannot afford to decrypt it at the server nor transfer the bulk of encrypted data to the client. The former compromises security since the potentially semi-trusted server needs to know decryption keys, and the latter compromises performance because of huge data transfers.

A solution called “ciphertext global search technology” is proposed by Xin Li in Chinese patent application publication No. CN1588365A. In the ciphertext global search technology, during an indexing phase, a data owner creates an index for all files firstly; then encrypts keywords in the index using a key yielding cipher index, encrypts the files using the same key yielding encrypted files, and encrypts the key with a public key; lastly, the data owner stores the cipher index, the encrypted files, and the encrypted key to the storage server. During a searching phase, the data owner firstly downloads the encrypted key from the storage server and decrypts it with a private key that corresponds to the public key before searching; secondly, the data owner encrypts a querying keyword with the key, and sends the encrypted keyword to the storage server; thirdly, the storage server looks up the cipher index for the same encrypted keyword; fourthly, the data owner retrieves the encrypted files according to the matching results and decrypts them with the key. If the data owner wants to authorize a searcher to search on the cipher index and encrypted files, he encrypts the key with the public key of the intended searcher and sends the encrypted key to the searcher.

With such solution, the data owner uses one single key to encrypt all the files. File encryption in most cases utilizes stream cipher. However, encrypting more than one file with a single key is known as an insecure approach. In addition, the data owner uses the same key to encrypt all the files and all the keywords. Thus, a searcher can retrieve all the data owner's files if the searcher ever performs a search of any keyword on the data owner's files. So, the above-mentioned ciphertext global search technology cannot well ensure security in the application shown in FIG. 1.

Another solution which is more complex is proposed by D. Boneh, G. D. Crescenzo, R. Ostrovsky, G. Persiano, “Public Key Encryption with Keyword Search”, EuroCrypt 2004; and R. Curtmola, J. Garay, S. Kamara, “Searchable Symmetric Encryption: Improved Definitions and Efficient Constructions”, CCS 2006. With such solution, during an indexing phase, a data owner firstly chooses some special fields in the files (such as the keyword “urgent” in an email) to create an index. To be concretely, for each file, the data owner encrypts special keywords. For example, <A=g^{r}, B=H₂(e(H₁(KW),h^{r})> is an “encrypted keyword”, where KW is a keyword, e: G₁×G₁−>G₂, g is a generator of G₁, H₁ and H₂ are two different hash functions, r is a random number in Z*ₚ, h is equal to g^{x}, x is secret key and also in Z*ₚ. Thus, the secure index is composed of a set of tuples, the form of the i-th tuple is <ciphertextᵢ: (A₁,B₁), . . . ,(Aₙ,Bₙ)>, where ciphertextᵢ is the ciphertext of Fileᵢ encrypted with the file encryption key K_{filei}. During a searching phase, the data owner first authorizes a searcher to query keyword by computing and issuing to the searcher a trapdoor for a keyword KW as T_{KW}=H₁^{x}(KW). Then, the searcher submits T_{KW} to the storage server. For each encrypted keyword of each file, the storage server computes B′=H₂(e(T_{KW}, A)) to test whether the file contains KW. If B=B′, the encrypted file is a matching output, and vice versa. If the searcher wants to decrypt the encrypted file, another round-trip with the data owner is necessary to fetch the corresponding decryption keys.

With the above solution, the computation complexity that the storage server spends on searching is O(m×n), where m is the number of files, n is the average number of distinct keywords in each file. For instance, given 1000 files and 10 keywords, it requires 30 seconds per search on the storage server equipped with 8 CPUs. Another disadvantage of such solution is that after the storage server returns matching results, i.e. encrypted files that contain the keyword, the searcher has to contact the data owner for the decryption keys of the encrypted files.

### SUMMARY OF THE INVENTION

The present invention is made in view of the problems in the prior art and provides a method, apparatus and system for searchable encryption.

With the novel fast searchable encryption solution according to the invention, one or more of the following or other important security dimensions are provided for outsourced storage with semi-trusted storage servers in the context of advanced content-based search:

Confidentiality—The data being stored on the server is not decipherable either during client-server transit, or at the server side, even by a malicious server.

Privacy of search—The keyword concerned in the search as well as the privacy level of the searcher will not be revealed to the server throughout the process of the search.

Multi-level retrieval—Every specific searcher can only obtain files revealable at his/her privacy level.

Confirmable decryption—Searchers are able to confirm the correctness of decryption of encrypted item in the index performed at searcher side.

Virtual deletion. The server can screen out deleted encrypted files from the search result to be provided to the searcher. The updating of the index after file deletion may be performed later with lower frequency and reduced influence on the service.

Locating items in the encrypted index—the server is provided with a capability of locating a file locator related to a specific file in the index with help of an additional parameter.

Updating of the encrypted index—the encrypted index can be fast updated to add or delete items about added or deleted files.

Fine-grained authorization—the authorization of search may be controlled in accordance with not only privacy levels but also keywords.

Chained authorization—a searcher at any privacy level is able to search on the files dominated at his/her privacy level, and a higher privacy level will dominate a lower privacy level.

According to one aspect of the invention, a method for searchable encryption is provided, comprising: setting one or more file locator generation keys; generating one or more keyword item set locators by mapping a string containing at least a keyword to a unique value; generating one or more file locators by encrypting file acquisition information of each of a plurality of files with at least one file locator generation key; and forming an encrypted index by one or more keyword item sets each being identified by a keyword item set locator and containing at least one or more file locators of the files associated with the corresponding keyword.

According to another aspect of the invention, an apparatus for searchable encryption is provided, comprising: an encryption/decryption setting unit configured to set one or more file locator generation keys; a keyword item set locator generation unit configured to generate one or more keyword item set locators by mapping a string containing at least a keyword to a unique value; and a file locator generation unit configured to generate one or more file locators by encrypting file acquisition information of each of a plurality of files with at least one file locator generation key; and an index forming unit configured to form an encrypted index by one or more keyword item sets each containing at least a keyword item set locator and one or more file locators of the files associated with the corresponding keyword.

According to yet another aspect of the invention, a method used in encrypted file search is provided, comprising: storing an encrypted index comprising one or more keyword item sets, each keyword item set being identified by a keyword item set locator and containing at least one or more file locators each accompanied by an index locator; receiving an index locating indicator; and deleting a file locator from a keyword item set if the index locator accompanying the file locator equals to a value calculated by mapping a string containing at least the file locator, the keyword item set locator identifying the keyword item set and the received index locating indicator.

According to yet another aspect of the invention, an apparatus used in encrypted file search is provided, comprising: a storage unit configured to store an encrypted index comprising one or more keyword item sets, each keyword item set being identified by a keyword item set locator and containing at least one or more file locators each accompanied by an index locator; and an index updating unit configured to delete a file locator from a keyword item set if the index locator accompanying the file locator equals to a value calculated by mapping a string containing at least the file locator, the keyword item set locator identifying the keyword item set, and a received index locating indicator.

According to another aspect of the invention, a method for encrypted file search is provided, comprising: receiving a keyword item set locator and a file locator decryption key; retrieving one or more file locators with the keyword item set locator; decrypting each file locator with the file locator decryption key to derive one or more encrypted resource identifiers and corresponding file decryption keys; retrieving one or more encrypted files identified by the one or more encrypted resource identifier; and decrypting each encrypted file with the corresponding file decryption key.

According to another aspect of the invention, an apparatus for encrypted file search is provided, comprising: a search request unit configured to generate a search request containing at least a keyword item set locator; a file locator decryption unit configured to decrypt one or more file locators with a file locator decryption key to derive one or more encrypted resource identifiers and corresponding file decryption keys; a file acquisition unit configured to retrieve one or more encrypted files identified by the one or more encrypted resource identifier; and a file decryption unit configured to decrypt each encrypted file with the corresponding file decryption key.

This invention enables the data owner to apply attribute-based and multi-level retrieval on the encrypted inverted index. All data and associated meta-data are encrypted at the data owner side using encryption, before being sent to the server. The data remains encrypted throughout its lifetime at the server. To enable content-based search on encrypted data, any stored files are indexed securely in the indexing phase at the data owner's site. This results in the confidential storage of the index structures at the server side, available for future secure client access. Virtual deletion is assured through filtering in the search result. Multi-level retrieval is achieved by limitation and the deployment of decryption keys corresponding to the searchers, either in accordance with the privacy level or keywords.

The invention adopts efficient search algorithms so as to scale the search to a large number of documents and keywords. By this invention, the searching time is O(log(N)) to O(1) where N is the number of total distinct keywords in the whole set of files. Therefore, compared to the prior art which requires O(m×n), this invention provides an efficient and viable solution.

### BRIEF DESCRIPTION OF THE DRAWINGS

The present invention will be better understood from the following detailed description of the preferred embodiments of the invention, taken in conjunction with the accompanying drawings in which like reference numerals refer to like parts and in which:

FIG. 1 is a diagram illustrating an example of use of storage service;

FIG. 2 is a diagram schematically illustrating an example of configuration of the system in which the invention is applied;

FIG. 3 is a block diagram schematically illustrating an example of configuration of the data owner terminal according one embodiment of the invention;

FIG. 4 is a flow chart schematically illustrating the operation of the data owner terminal according to one embodiment of the invention;

FIG. 5 is a flow chart schematically illustrating an example of process of generating the encrypted inverted index according to one embodiment of the invention;

FIG. 6 is a diagram schematically illustrates an example of data flow of the indexing phase according to one embodiment of the invention;

FIG. 7 is a block diagram schematically illustrating an example of configuration of the server according to one embodiment of the invention;

FIG. 8 is a block diagram schematically illustrating an example of configuration of the searcher terminal according to one embodiment of the invention;

FIG. 9 is a flow chart schematically illustrating the process of searching according to one embodiment of the invention;

FIG. 10 is a diagram schematically illustrating an example of data flow of the searching phase according to one embodiment of the invention;

FIG. 11 is a diagram schematically illustrating an example of data flow of filtering process in the searching phase according to one embodiment of the invention;

FIG. 12 is a block diagram schematically illustrating an example of configuration of the data owner terminal according one embodiment of the invention;

FIG. 13 is a diagram schematically illustrating an example of data flow of the indexing phase according to one embodiment of the invention;

FIG. 14 is a block diagram schematically illustrating an example of configuration of the server according one embodiment of the invention;

FIG. 15 is a flow chart schematically illustrating the process of the server for updating the encrypted index when an encrypted file is to be deleted according to one embodiment of the invention;

FIG. 16 is a diagram schematically illustrating an example of data flow of the update of the encrypted index according to one embodiment of the invention; and

FIG. 17 is a diagram schematically illustrating another example of data flow of the update of the encrypted index according to one embodiment of the invention.

### DESCRIPTION OF THE PREFERRED EMBODIMENTS

The present invention will be described below with reference to the drawings. In the following detailed description, numerous specific details are set forth to provide a full understanding of the present invention. It will be obvious, however, to one ordinarily skilled in the art that the present invention may be put into practice without some of these specific details. In the drawings and the following description, well-known structures and techniques are not shown in detail so as to avoid unnecessarily obscuring the present invention.

FIG. 2 is a diagram schematically illustrating a system in which the invention is applied. Three parties are involved in the system: at least one data owner, at least one service provider and one or more searchers. As shown in FIG. 2, a data owner's apparatus or terminal, a server managed by the service provider and one or more searchers' apparatus or terminals are connected and communicable with each other via a communication network. Each of the apparatus or terminal of the data owner and searchers may be implemented as a device capable of processing and communicating information, for example, a personal computer (PC), a personal digital assistant (PDA), a smart mobile phone, or other data processing device. The server is generally implemented as a device or a set of devices capable of storing and maintaining an amount of data and enabling conditional access by the terminals to data, and managed by a service provider.

In the system of the invention, the data owner encrypts his/her files and associated meta-data, and stores the ciphertext to the server. The files remains encrypted throughout its lifetime at the server. To enable content-based search on the encrypted files, the data owner generates an encrypted index according to each keyword of the files, and stores the encrypted index to the server. The index is an inverted index and remains encrypted as it is stored at the server. To authorize a searcher to search on the encrypted index and retrieve certain files containing one or more specified keywords, the data owner issues necessary data including particular decryption key to the searcher. Then, with data issued by the data owner, the searcher may search for encrypted files stored on the server by a search request, and as a result, retrieve the related encrypted files from the server and obtain the plaintext of the files by decryption with the issued decryption key.

According to the invention, encrypted files are indexed with a novel encrypted inverted index composed of one or more Keyword Item Sets (KIS). The data being stored on the server is not decipherable either during client-server transit, or at the server side, even by a malicious server. Every specific searcher can only retrieve and decrypt the encrypted files corresponding to a file locator decryption key of certain privacy level issued to that searcher. The encrypted files can be excluded in search after being deleted, while the actual update of the encrypted inverted index may be performed conditionally later.

The features of various aspects of the invention and the exemplary embodiments will be described in more detail below. It should be noted that the following description of the embodiments is only for the purpose of better understanding of the invention by illustrating examples of the invention. The invention is never limited to any specific configuration and algorithm set forth below, but covers any modifications, alternatives and improvements of the elements, components and algorithms, as long as not departing from the spirit of the invention.

### [Encryption and Search]

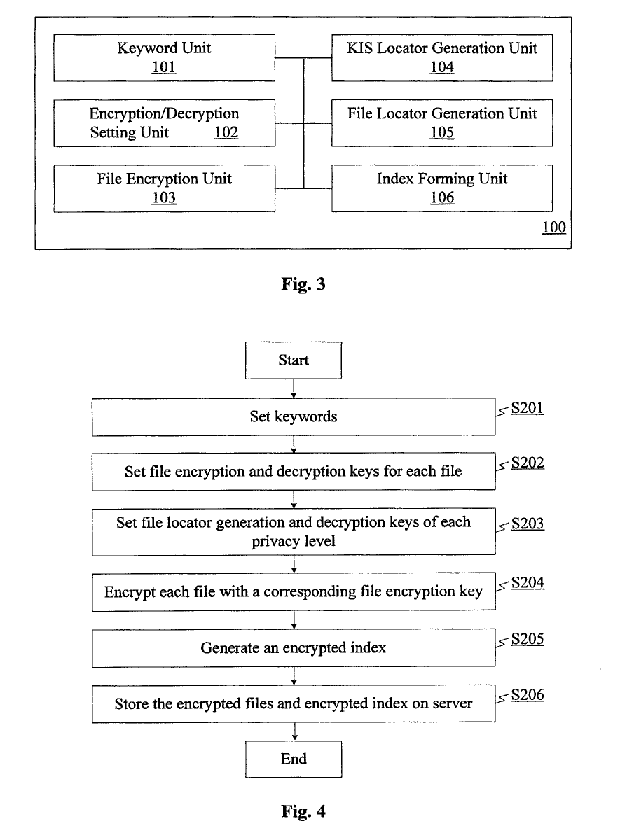

FIG. 3 is a block diagram schematically illustrating the configuration of the data owner terminal according one embodiment of the invention. As shown in FIG. 3, the data owner terminal 100 mainly comprises a keyword unit 101, an encryption/decryption setting unit 102, a file encryption unit 103, a KIS locator generation unit 104, a file locator generation unit 105 and an index forming unit 106.

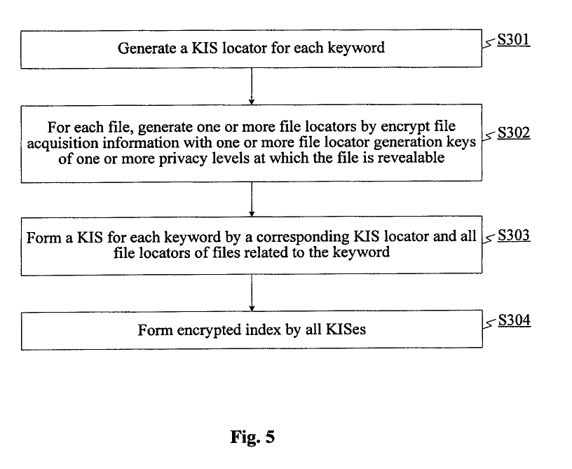

The operation of the data owner terminal 100 according to the embodiment will be described with reference to FIGS. 4 and 5. FIG. 4 is a flow chart schematically illustrating the operation of the data owner terminal, and FIG. 5 is a flow chart illustrating an example of process of generating the encrypted inverted index.

As shown in FIG. 4, at step S201, the keyword unit 101 sets association between each file and one or more keywords contained in or related to the file. This may be done by extracting the keywords from the files or by inputs from the user. Also, the association of the file and keywords may be set in advance by the data owner and stored as a table in storage means in the data owner terminal, or received from remote location. In such situation, the keyword unit 101 is not necessary for the configuration of the data owner terminal.

At step S202, the encryption/decryption setting unit 102 sets file encryption and decryption keys for each file. The file encryption key is used to encrypt the corresponding file and the file decryption key is used to decrypt the corresponding encrypted file. The file encryption/decryption keys may be set arbitrarily according to any encryption method. In the present invention, the file encryption key and the file decryption key for a file may be set differently with asymmetric encryption scheme. However, a single key may be used as both file encryption key and file decryption key of a file in the invention with symmetric encryption scheme. In such case, the file decryption key and the file encryption key for the same file are the same in the description below.

At step S203, the encryption/decryption setting unit 102 further sets and allocates file locator generation and decryption keys used in search, which will be explained in detail below.

File locator generation key is used to encrypt file acquisition information of a file to generate a file locator in the encrypted index, which will be described later, and the file locator decryption key is used to decrypt the file locator in the encrypted index. In this embodiment, a plurality of file locator generation and decryption key pairs may be set in accordance with different privacy levels.

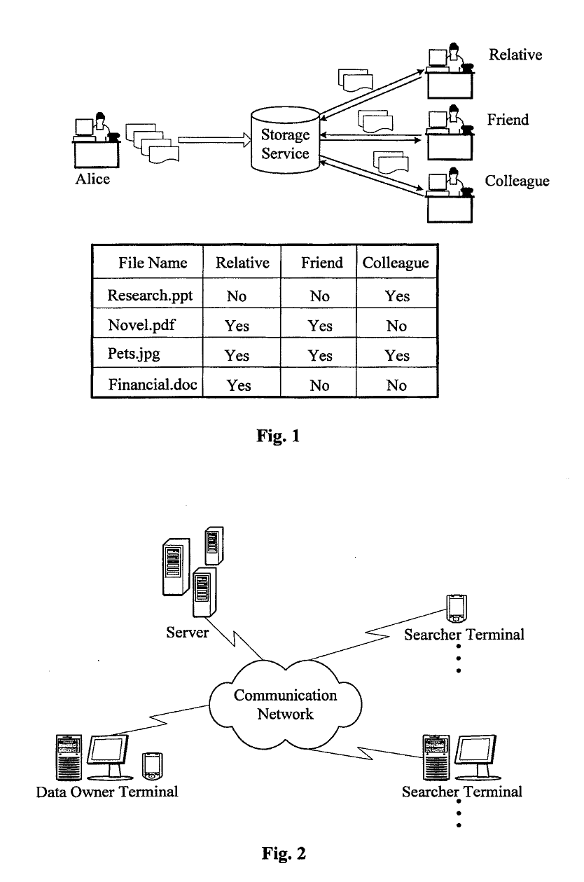

For example, in the situation shown in FIG. 1, three privacy levels are needed: level 1 for relatives, level 2 for friends and level 3 for colleagues. As will be described below, searchers at different privacy levels are enabled to search and decrypt the files revealable at his/her privacy level, but kept blind to the files unrevealable at his/her privacy level. In the above example, three pairs of file locator generation and decryption keys are set each for one of the three privacy levels: EKey₁/DKey₁ for level 1, EKey₂/DKey₂ for level 2 and EKey₃/DKey₃ for level 3. As used here and hereinafter, EKey denotes file locator generation key, DKey denotes file locator decryption key.

Also, the file locator generation key and the corresponding file locator decryption key may set arbitrarily according to any encryption method. They can be set differently with asymmetric encryption scheme or set to be the same with symmetric encryption scheme. With symmetric encryption scheme, the file locator decryption key and the file locator generation key of the same pair are the same.

For example, the file locator generation and decryption keys of privacy level m may be generated as follow:

EKeyₘ=DKeyₘ=Hash(MEK∥m) (Equation 1)

where Hash(MEK∥m) is a hash function with the key MEK, “∥” denotes combination of strings or numbers in a predetermined order, and MEK is a master encryption key of the data owner, which may be chose by the encryption/decryption setting unit 102, or issued from any other authority. Obviously, values of any other similar algorithm may be also used as the file locator generation and decryption keys.

The data owner may keep the algorithm and related parameters necessary to compute the file locator generation and decryption keys, for example, in the encryption/decryption setting unit 102, for later calculation of the file locator generation and decryption keys. For example, the data owner terminal stores the master encryption key MEK, and calculates the file locator generation and decryption keys by Equation 1 when authorizing a searcher at a particular privacy level in later phases after the encrypted index is established. In this way, the data owner is not required to store all file locator generation and decryption keys after the encrypted index is established. Alternatively, the data owner terminal may store a mapping table locally, for example, in the encryption/decryption setting unit 102. In the later phases, if the file locator generation and decryption keys of a particular privacy level are needed, the data owner terminal simply looks up the mapping table to find the corresponding keys.

Now, turn back to FIG. 4. After the file encryption and decryption keys for each file are set, the file encryption unit 103 encrypts each file with a corresponding file encryption key at step S204.

At step S205, the index forming unit 106 forms an encrypted inverted index composed of one or more Keyword Item Sets (KISes) based on the keywords of the files. Each KIS according to this embodiment corresponds to one keyword. The particular method of generating the index according to this embodiment will be described with reference to FIG. 5.

FIG. 5 illustrates an example of the process of generating the encrypted inverted index according to the embodiment. For a keyword KWᵢ, the KIS locator generation unit 104 generates a unique KIS locator KLᵢ as a unique identifier of the KIS of the keyword KWᵢ at step S301. The KIS locator KLᵢ may be generated arbitrarily as long as it uniquely corresponds to the keyword KWᵢ and without the help of the data owner, any one else cannot calculate the keyword KWᵢ from KLᵢ. Generally, the KIS locator generation unit 104 maps each keyword to a unique value through any available algorithm to generate the KIS locator for each keyword. For example, the KIS locator KLᵢ may be generated as follow:

KLᵢ=Hash(MEK∥KWᵢ) (Equation 2)

It should be noted that Hash function as used in this description is only one instance out of many mapping algorithms as appreciated by those skilled in the art, and the invention is not limited to such algorithm.

At step S302, the file locator generation unit 105 generates one or more file locators for each file according to one or more privacy levels at which the file is revealable. In particular, if a file FILEⱼ is revealable at a privacy level m, the file locator generation unit 105 generates a file locator FILE_{j,m} of FILEⱼ by encrypting the file acquisition information of FILEⱼ with the file locator generation key EKeyₘ allocated for the privacy level m. If the file is revealable at multiple privacy levels, the file locator generation unit 105 generates multiple file locators for the file, each corresponding to one of the multiple privacy levels and generated with a respective file locator generation key.

For example, in the situation shown in FIG. 1, Alice wishes the files Novel.pdf, Pets.jpg and Financial.doc are revealable at privacy level 1, the files Novel.pdf and Pets.jpg are revealable at privacy level 2, and the files Research.ppt and Pets.jpg are revealable at privacy level 3. The levels at which each file is revealable in this example are listed in Table 1.

TABLE 1

| | Level 1 | Level 2 | Level 3 |
|---|---|---|---|
| Research.ppt | No | No | Yes |
| Novel.pdf | Yes | Yes | No |
| Pets.jpg | Yes | Yes | Yes |
| Financial.doc | Yes | No | No |

Taking the file Novel.pdf revealable at privacy level 1 and privacy level 2 as the example, the file locator generation unit 105 will encrypt the file acquisition information of Novel.pdf with the file locator generation key EKey₁ of privacy level 1 to generate a file locator FL_{novel.pdf,1} and encrypt the file acquisition information with the file locator generation key EKey₂ of privacy level 2 to generate a file locator FL_{novel.pdf,2}.

The file acquisition information includes necessary information for fetching encrypted files from the server and information for decrypting the encrypted files. For example, the file acquisition information of FILEⱼ is CFNⱼ∥K_{filej}, where CFNⱼ is an encrypted resource identifier for identifying the encrypted file of FILEⱼ, and K_{filej} is the file decryption key of FILEⱼ set by the encryption/decryption setting unit 102. The encrypted resource identifier CFNⱼ may be the encrypted file name of FILEⱼ, or a URL of the ciphertext of FILEⱼ.

In accordance with this embodiment, the file locator FL_{j,m} for FILEⱼ at privacy level m is generated as follow:

FL_{j,m}=E(EKeyₘ, CFNⱼ∥K_{filej}) (Equation 3)

where E(X, Y) is an encryption function denoting encrypting Y by X.

Back to FIG. 5, after the KIS locator generation unit 104 generates the KIS locator KLᵢ for each keyword KWᵢ and the file locator generation unit 105 generates the file locators for all files, the index form unit 106 forms a KIS for each keyword KWᵢ by the corresponding KIS locator KLᵢ and all file locators of the files related to that keyword at step S303.

Taking the situation shown in FIG. 1 and Table 1 as an example and assuming that the file Research.ppt and Novel.pdf are associated with a keyword KWₐ, the KIS for the keyword KWₐ is generated as a tuple <KLₐ: FL_{Research.ppt, 3}=E(EKey₃, CFN_{Research.ppt}∥K_{Research.ppt}), FL_{Novel.pdf, 1}=E(EKey₁, CFN_{Novel.pdf}∥K_{Novel.pdf}), FL_{Novel.pdf, 2}=E(EKey₂, CFN_{Novel.pdf}∥K_{Novel.pdf})> according to this embodiment.

For each keyword, the index form unit 106 forms a KIS, and at step 304, the index forming unit 106 forms the encrypted index by all KISes.

It is notable that the KIS locators may be putted outside the KIS and merely organized and handled as identifiers of KISes. In such case, a mapping relation is created between each KIS locator and the corresponding KIS, instead of taking the KIS locator as a part of the KIS. The encrypted index can be organized into a standard (e.g. tree-based) data structure according the unique KIS locators, and the KIS locators specify the exact positions in the encrypted index, so the server can find it in logarithmic time, just like for unencrypted data.

Turn back to FIG. 4. At step S206, the data owner terminal 100 stores the encrypted files and the encrypted index to the server. The communication between the data owner terminal and the server as well as the searcher may be performed by a communication unit not shown. It should be noted that the term “server” as used herein may be a single apparatus providing both storage and search services, or a set of multiple apparatus adjacent or remote to each other, each responsible for different services such as storage, data search, user management and the like, or shares the burden of a service. For example, the data owner terminal 100 may stores the encrypted files on a storage server, and stores the encrypted index on a file search server which is communicable with the storage server. To simplify the description, all such apparatus providing the services are generally referred to as “server”.

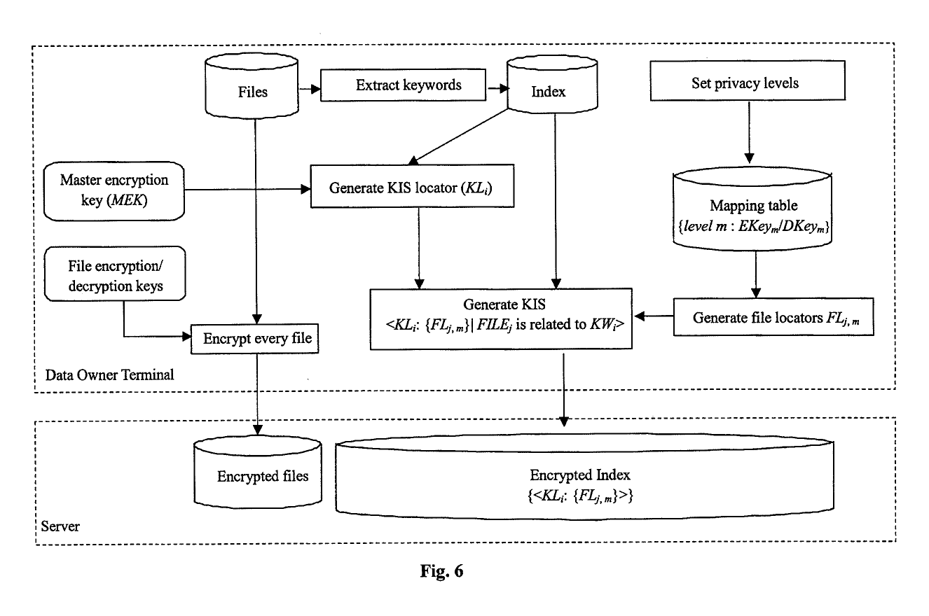

To help to understand the process of the indexing phase according to this embodiment, FIG. 6 illustrates the schematic data flow of the example described above.

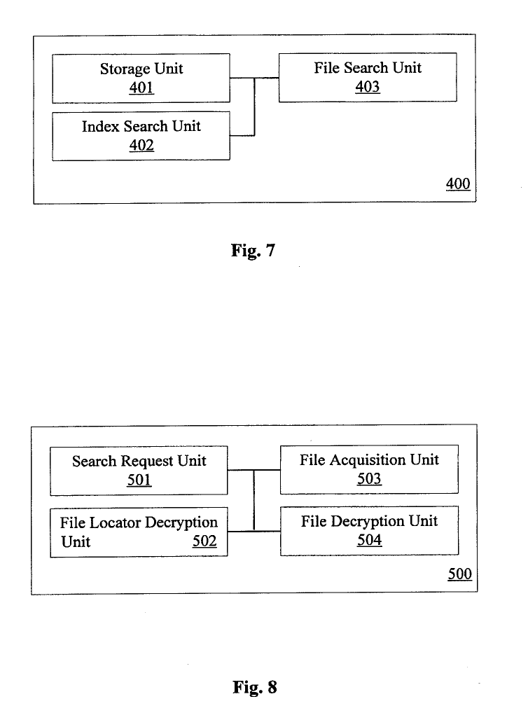

The process of the data owner terminal in an indexing phase according to one embodiment of the invention is described above. The configurations of the server and the searcher terminal as well as the process in searching phase will be described blow with reference to FIGS. 7-9.

FIG. 7 schematically illustrates a configuration of an example of the server according to one embodiment of the invention, and FIG. 8 schematically illustrates a configuration of an example of the searcher terminal according to one embodiment of the invention.

As shown in FIG. 7, the server 400 mainly comprises a storage unit 401 for storing the encrypted files and the encrypted index received from the data owner, an index search unit 402 for performing search in the encrypted index in response to the searcher's request and a file search unit 403 for searching for the encrypted files identified by particular encrypted resource identifiers.

As shown in FIG. 8, the searcher terminal 500 mainly comprises a search request unit 501 for generating a search request, a file locator decryption unit 502 for decrypting the file locators, a file acquisition unit 503 for generating file acquisition request and a file decryption unit 504 for decrypting the acquired encrypted files.

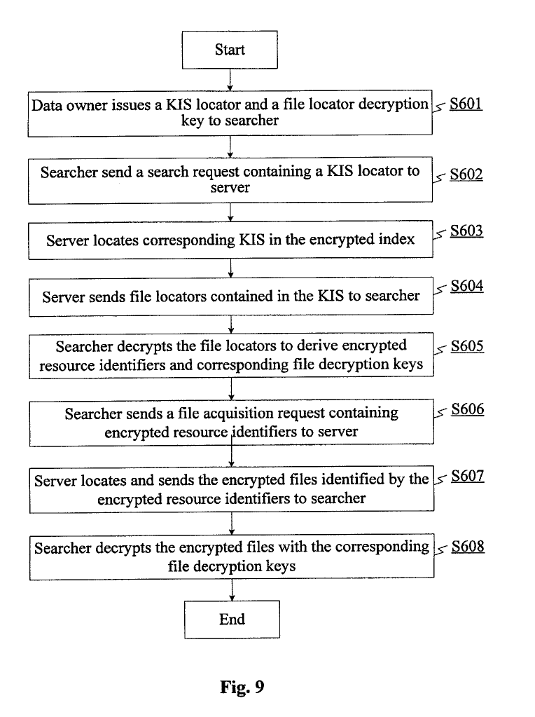

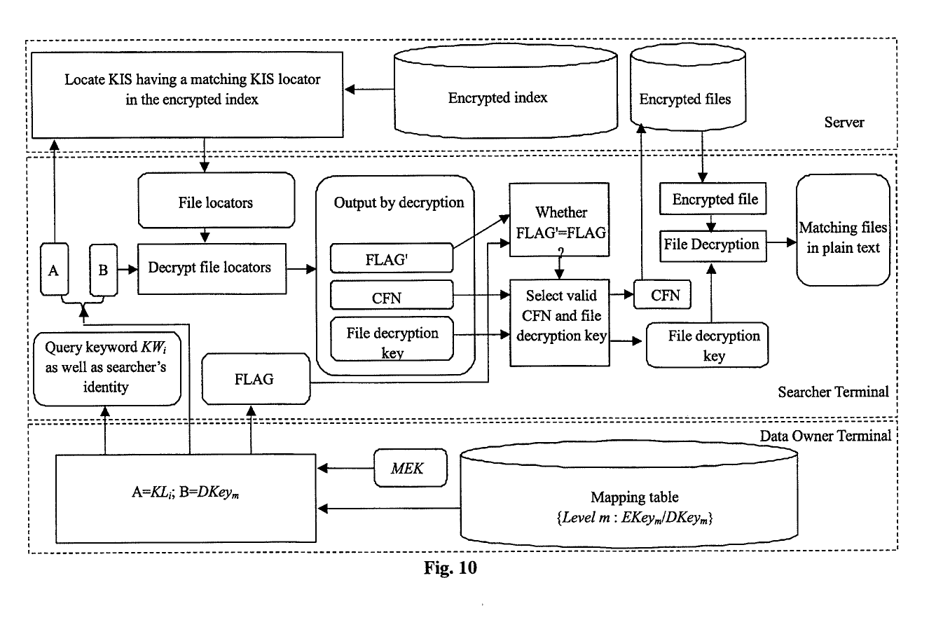

An example of the process of searching according to the embodiment of the invention will be described with reference to FIG. 9.

Firstly, at step S601, if the data owner wants to enable a searcher to search on a keyword, the data owner issues, in a secure manner, to the searcher the KIS locator of the keyword as well as a file locator decryption key of suitable privacy level authorized to the searcher. The data owner may notify each searcher of the respective KIS locator and file locator decryption key via various ways, for example, automatically by electrical message sent via communication networks between the data owner terminal and the searcher terminal, orally or by written form. The authorization may be performed in response to a searcher's request. For example, the searcher may send a request containing one or more keywords he/she wishes to search on to the data owner by, for example, a search capability request unit (not shown). After confirming the identity of the searcher, the data owner may decide the privacy level suitable for the searcher and issue the searcher with the KIS locator(s) of the requested keyword(s) and the file locator decryption key of the decided privacy level. The KIS locators and the file locator decryption key may be retrieved from the tables stored at the data owner terminal, or calculated online by the data owner terminal according to the stored security parameters. The process of authorization may be performed by, for example, an authorization unit (not shown) in the data owner terminal. In some situations, security authentication may be required for the searcher to obtain authorization from the data owner.

In the searching phase, the searcher terminal generates a search request containing a KIS locator by the search request unit 501 and transmits the search request to the server, as shown in step S602.

After the server receives the request containing the KIS locator from the searcher terminal, the server performs search by the index search unit 402 in the encrypted index stored in the storage unit 401 to find out a KIS the KIS locator of which is the same as that received in the request, as shown in step S603. Then, the server sends the file locators contained in the matching KIS to the searcher terminal at step S604. As described above, each of these file locators is generated by encrypting the file acquisition information of a file associated with the keyword corresponding to the KIS with a file locator generation key.

After receiving the file locators from the server, the searcher terminal decrypts each file locator by the file locator decryption unit 502 with the file locator decryption key issued by the data owner to derive file acquisition information of each file, which contains the encrypted resource identifier and the corresponding file decryption key of the file, as shown in step S605. As described above, each file locator is generated by encrypting the file acquisition information with a file locator generation key of certain privacy level by the data owner. With the file locator decryption key of specific privacy level, the searcher cannot decrypt the file locator encrypted with other file locator generation keys of other privacy levels. This ensures that the searcher can obtain the encrypted resource identifiers and the corresponding file decryption keys of the files revealable at the privacy level authorized by the data owner, but cannot obtain correct encrypted resource identifiers and file decryption keys of the files non-revealable at that privacy level.

Then, the searcher terminal generates a file acquisition request by the file acquisition unit 503, which contains the encrypted resource identifiers obtained in step S605, and then sends the file acquisition request to the server at step S606.

After receiving the file acquisition request containing the encrypted resource identifiers from the searcher, the file search unit 403 of the server finds among the stored encrypted files any encrypted files matching the received encrypted resource identifiers at step S607. Upon locating the matching encrypted files, the server sends these matching encrypted files to the searcher terminal.

Upon receiving the encrypted files, the searcher terminal decrypts the encrypted files by the file decryption unit 504 with the corresponding file decryption keys at step S608. Thus, the searcher can obtain the files as the search result.

It is notable that at step S605, the searcher will not get correct encrypted resource identifiers and file decryption keys of the files non-revealable at the privacy level the data owner set to him/her. If the searcher wrongly decrypts a file locator(s) of any other privacy level and sends the obtained incorrect encrypted resource identifier(s) to the server, the server will not locate a correct encrypted file(s) and so the encrypted files only revealable at other privacy levels will not be provided to the searcher. Even if the searcher obtains such encrypted files from the server occasionally, the searcher is not able to correctly decrypt these files. This ensures that the searcher can only search on and see the files containing the specific keyword and revealable at particular privacy level set by the data owner. It's also notable that all the files are not revealed to the server during the whole process.

Although not shown in the flow chart, it is notable that if one or more encrypted resource identifier obtained by the searcher at step S605 are URLs as described above, the searcher may obtain the encrypted files directly by these URLs, rather than send these URLs to the searcher. Alternatively, the searcher still sends these URLs to the server and the file search unit 403 of the searcher will fetch the encrypted files from the network location identified by these URLs.

In the example described above, the searcher sends one KIS locator to the searcher in one search. It is conceivable that the searcher may send multiple KIS locators in a search request to the searcher to perform search on multiple keywords in the case of that the searcher is issued with multiple KIS locators by the data owner.

### [Confirmable Decryption]

In the above embodiment, the file locators of other privacy level would be wrongly decrypted by the searcher, and the invalid information may be transferred and processed. Whereas, in an alternative embodiment of the invention, correctness of decryption of each file locator is checked at searcher side before the searcher sends the file acquisition request to the server, so as to avoid transfer of invalid encrypted resource identifiers and process of locating encrypted files by the invalid encrypted resource identifiers at server side. The confirmable decryption may be implemented by confirming a known value encrypted together with the file acquisition information when the file locator is generated, for example, a flag accompanying the file acquisition information. One example of such implementation is described below.

In this embodiment, the file acquisition information of a file FILEⱼ is extended to FLAG∥CFNⱼ∥K_{filej}, where FLAG is an arbitrary value or other character selected by the data owner.

The process at the indexing phase is basically the same as that described in the above embodiment, except for that instead of Equation 2, the data owner terminal generates the file locator of FILEⱼ at step 304 as follow:

FL_{j,m}=E(EKeyₘ, FLAG∥CFNⱼ∥K_{filej}) (Equation 4)

At the searching phase, the data owner terminal transmits FLAG in addition to the KIS locator and the file locator decryption key to the searcher terminal at step S601.

The process for the searcher terminal to obtain file locators from the server is the same as that in the above embodiment. In decrypting the received file locators, the file locator decryption unit 502 of the searcher terminal checks whether the flag contained in the decrypted file locator is the same as the flag received from the data owner. If there is a matching, it indicates that the decryption of the file locator is correct, and right file acquisition information is obtained. If not, it indicates that the decryption of the file locator fails due to wrong file locator decryption key or any other reason. Thus, confirmable decryption is implemented by using the flag. To help to understand the process of the searching phase according to this embodiment, FIG. 10 illustrates the schematic data flow of such case.

By the confirmation describe above, the searcher terminal may select and send the correct encrypted resource identifiers to the server to fetch the corresponding encrypted files, and use the correct file decryption keys to decrypt the received files.

With check of the flag in this embodiment, invalid encrypted resource identifiers are prevented from transferring to the server and the server may locate the encrypted files more effectively.

The flag may be initially selected by the encryption/decryption setting unit 102 of the data owner terminal and then be informed to the searcher. Alternatively, a number known to both the data owner and the searcher may be set in advance as the flag. In other embodiment, different flags may be used for different privacy levels, or for different files. As will be appreciated by those skilled in the art, other kinds of parameters and algorithms may be applied in the invention for confirmable decryption.

### [Virtual Deletion]

As known, updating of the index after deletion of one or more files is relatively complex and generally takes large amount of computational resources and time, while the operation of deletion per se is relatively fast and easy to perform. In view of this, updating the encrypted index immediately after an encrypted file is deleted is inefficient. It is desirable that the updating of the index is performed with lower frequency. For example, the updating is performed every day, every week or every month and so on, or performed once after a predetermined number of encrypted files are deleted. It is also desirable that the updating of the index may be scheduled so as to reduce the duration and influence of out-of-service. For example, the updating of the index is performed in a time period when fewer searchers will access to the search service, for example, sometime in midnight.

However, to ensure correctness of search after one or more encrypted files are deleted from storage service, it is necessary to screen out the deleted encrypted files from the search result before the encrypted index is updated. We call such operation as virtual deletion.

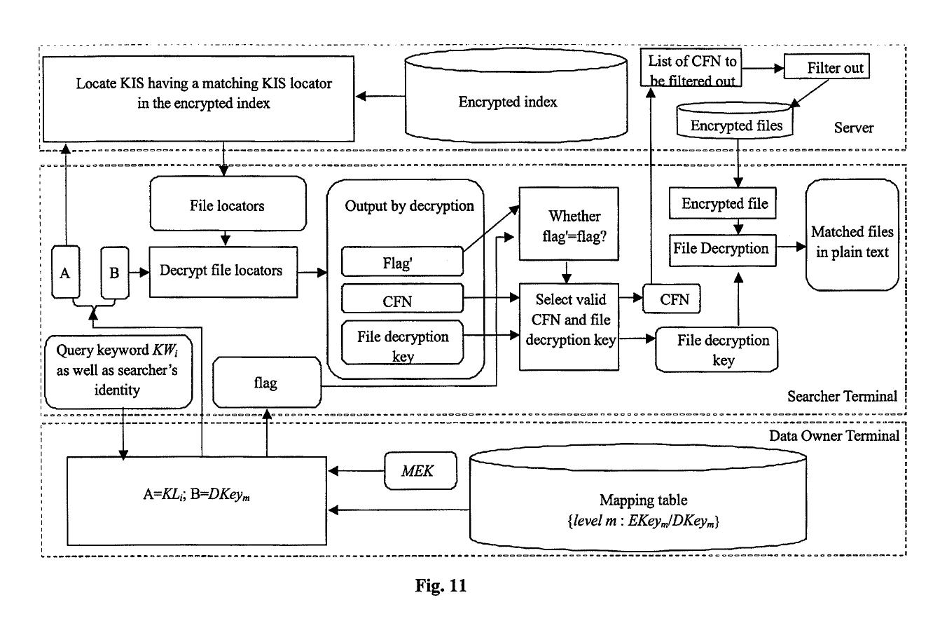

By filtering out some files in accordance with certain condition in providing encrypted files to the searcher, the server is provided with ability of virtual deletion in the invention. For example, the data owner sends a list of encrypted resource identifiers of the encrypted file to be deleted, for example {CFN₂, CFN₄}, to the server, and the server deletes the corresponding encrypted files. After that, when the server receives a list of encrypted resource identifiers, for example {CFN₁, CFN₂, CFN₃, CFN₄, CFN₅}, from the searcher, the file search unit 403 of the server firstly filters out the deleted files, that is, filters the list as {CFN₁, CFN₂, CFN₃, CFN₄, CFN₅}−{CFN₂, CFN₄}={CFN₁, CFN₃, CFN₅}. Then, the server only locates and returns the encrypted files corresponding to the filter-out results {CFN₁, CFN₃, CFN₅} to the searcher. FIG. 11 illustrates the schematic data flow of such example.

In the virtual deletion, the encrypted files to be deleted may be labeled by some special symbol rather than actually deleted. After receiving the confirmation instruction from the data owner or other prescribed condition is satisfied, the server may perform actual deletion of the encrypted files.

In addition to the virtual deletion, the filtering may be also applied in other situations and the conditions of the filter may be designed according to any particular application.

### [Locating and Updating in the Encrypted Index]

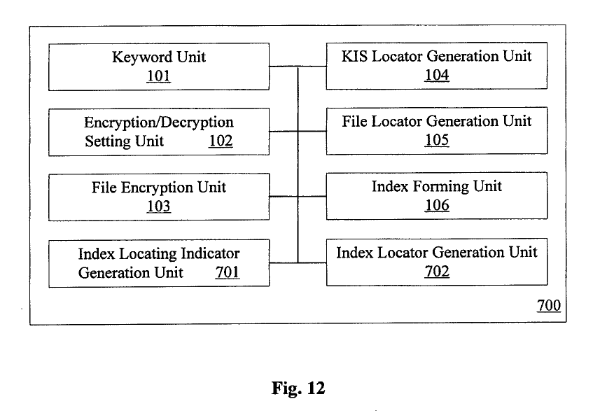

By extending each KIS in the encrypted index, a capability of locating a file locator(s) related to a specific file is provided in the invention. For example, after an encrypted file is deleted from the server, the file locators related to this encrypted file should be removed from the encrypted index. With additional parameter added in each KIS according to the invention, the server is enabled to locate the file locators related to a specified file with the help of the data owner while the content of the file and the keywords contained therein are not revealed to the server. Such embodiment of the invention will be described below with reference to FIGS. 12-17.

FIG. 12 illustrates an exemplary configuration of the data owner terminal 700 according to one embodiment of the invention. As shown in FIG. 12, the data owner terminal 700 comprises all units as shown in FIG. 3, and further comprises an index locating indicator generation unit 701 for generating index locating indicators and an index locator generation unit 702 for generating index locators associated with file locators. The functions and operations of the keyword unit 101, the encryption/decryption setting unit 102, the file encryption unit 103, the KIS locator generation unit 104 and the file locator generation unit 105 in this embodiment are the same as described above. The following description only focus on the difference of this embodiment from the embodiments described above.

In this embodiment, each KIS in the encrypted index is extended by accompanying each file locator with an index locator which is mapped from the file locator, the corresponding KIS locator and an index locating indicator generated by the data owner terminal.

Particularly, in the indexing phase, the index locating indicator generation unit 701 of the data owner terminal 700 generates an index locating indicator for each file by mapping the encrypted resource identifier of the file to a unique value. For example, for a file FILEⱼ, the index locating indicator generation unit 701 generates an index locating indicator xⱼ as follow:

xⱼ=Hash(CFNⱼ∥sk) (Equation 5)

where CFNⱼ is the encrypted resource identifier of FILEⱼ and sk is a secret key held by the data owner, for example, the private key held by the data owner. As mentioned before, any one way mapping method can be used instead of hash function.

In addition to the KIS locators and the file locators, the data owner terminal 700 in accordance with this embodiment also generates an index locator for each file locator contained in a KIS by the index locator generation unit 702. Each index locator is generated by mapping a combination of the corresponding file locator, the KIS locator and the index locating indicator generated by the index locating indicator generation unit 701 to a value. For example, for a file locator FL_{j, m} related to FILEⱼ in a KIS having a KIS locator KLᵢ, the index locator generation unit 702 generates an index locator IL_{i,j, m} as follow:

IL_{i,j, m}=Hash(KLᵢ∥FL_{j, m}∥xⱼ) (Equation 6)

where xⱼ is the index locating indicator for FILEⱼ, which is generated by the index locating indicator generation unit 701.

Then, the index forming unit 106 of the data owner terminal 700 forms the encrypted index by one or more KIS each contains a KIS locator, one or more file locators generated as in the above embodiments and one or more index locators each accompanying a corresponding file locator. Taking the situation shown in FIG. 1 and Table 1 as an example and assuming that the file Research.ppt and Novel.pdf are associated with a keyword KWₐ, the KIS for the keyword KWₐ is generated as a tuple <KLₐ: FL_{Research.ppt, 3}, IL_{a, Research.ppt, 3}=Hash (KLₐ∥FL_{Research.ppt, 3}∥x_{Research.ppt}), FL_{Novel.pdf, 1}, IL_{a, Novel.pdf, 3}=Hash (KLₐ∥FL_{Novel.pdf, 3}∥x_{Novel.pdf}), FL_{Novel.pdf, 2}, IL_{a, Novel.pdf, 3}=Hash (KLₐ∥FL_{Novel.pdf, 3}∥x_{Novel.pdf})> according to this embodiment. The encrypted index generated as such is sent to and stored on the server.

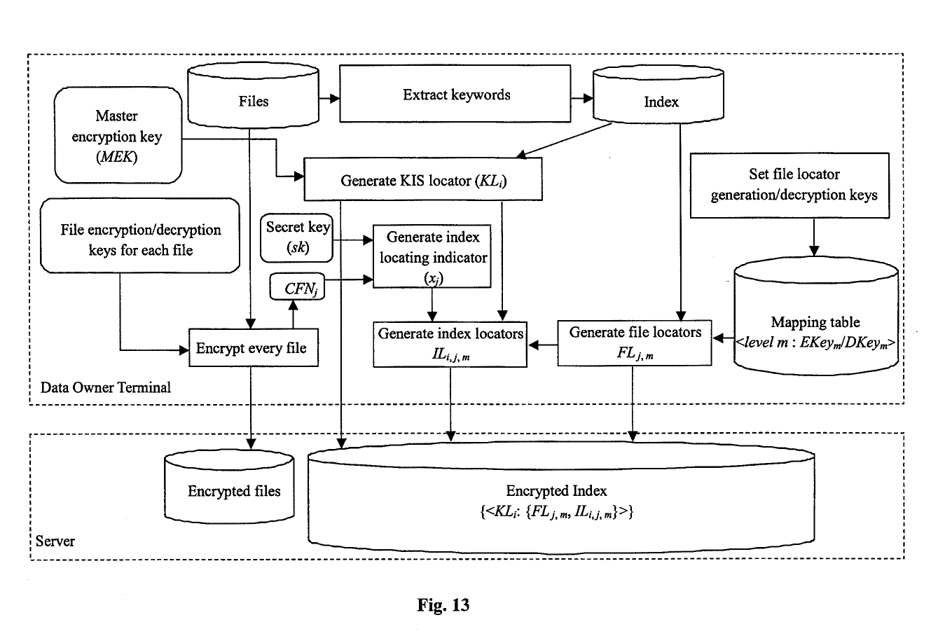

The data flow of the indexing phase according to this embodiment is schematically illustrated in FIG. 13.

The process of updating the encrypted index after an encrypted file is deleted is described below.

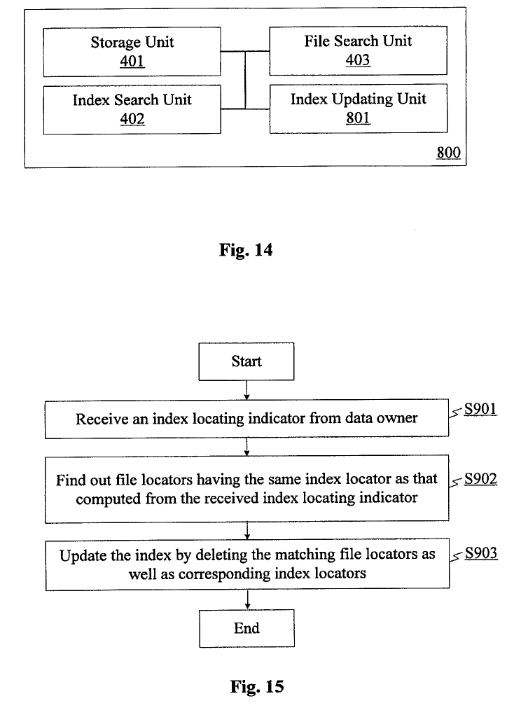

FIG. 14 illustrates an exemplary configuration of the server according to this embodiment. As shown in FIG. 14, the server 800 comprises all units as shown in FIG. 7, and further comprises an index updating unit 801 for updating the stored encrypted index. The functions and operations of the storage unit 401, the index search unit 402 and the file search unit 403 in this embodiment are the same as described above. The following description only focus on the difference of this embodiment from the embodiments described above.

FIG. 15 is a flow chart illustrating the process of the server for updating the encrypted index after an encrypted file is deleted.

When a file FILEₐ is to be removed from the encrypted index, for example, when the encrypted file FILEₐ is deleted from the storage service on the server and so the index needs to be updated, the data owner terminal 700 transmits a message containing the index locating indicator xₐ of FILEₐ calculated by the index locating indicator generation unit 701 to the server 800. At step S901, the server 800 receives the index locating indicator xₐ from the data owner terminal 800.

Then, for each file locator in each KIS in the stored encrypted index, the index updating unit 801 of the server 800 computes an index locator by using the received index locating indicator xₐ with the same mapping method as used by the data owner terminal in generating the encrypted index. For example, for a file locator FL_{j, m} in a KIS having a KIS locator KLᵢ, the index updating unit 801 computes IL′_{i,j,m}=Hash (KLᵢ∥FL_{j, m∥x}ₐ) by using the same hash function as described above. Then, the index updating unit 801 checks whether the computed IL′_{i, j, m} is equal to the index locator IL_{i, j, m} accompanying the file locator FL_{j, m} contained in the KIS. If the two value matches, it indicates that the corresponding file locator should be deleted. By such, at step S902, the index updating unit 801 finds out all file locators to be deleted.

Then, at step S903, the index updating unit 801 of the server 800 deletes all matching file locators found as well as the accompanied index locators from the encrypted index stored in the storage unit 401, so as to update the encrypted index.

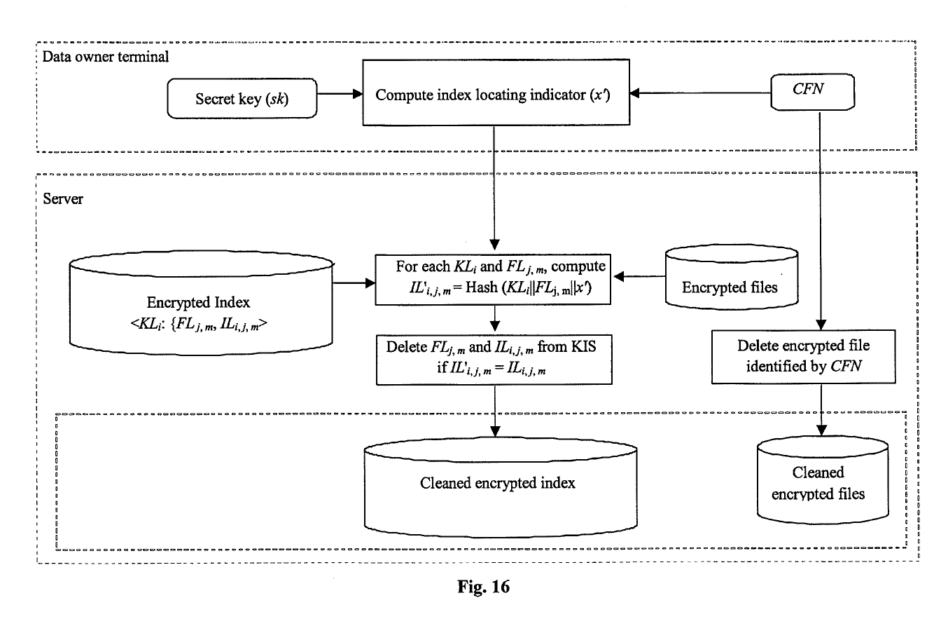

The data flow of the update of the encrypted index as described above is schematically illustrated in FIG. 16.

In the above example, the server checks the file locators in all KISes in the encrypted index. Alternatively, the data owner may transmit the KIS locators of all KISes related to the deleted file to help the server to reduce the search scope to the KISes having the matching KIS locators.

The KIS locators of the KISes related to the file may be originally stored in the data owner terminal in the indexing phase, or the data owner terminal keeps information of the keywords of each file in advance and computes the KIS locators in the updating phase. It is also conceivable that the data owner fetches the encrypted file identified by an encrypted resource identifier before the encrypted file is deleted from the server, decrypt the encrypted file, extracts the keywords from the decrypted file, and computes and sends the KIS locators related to the file to be deleted to the server. In such case, the data owner also acts as a searcher and may comprise the related units as shown in FIG. 8.

Upon getting the KIS locators and index locating indicator from the data owner terminal, the server may merely check the file locator in the KISes identified by the received KIS locators. Thus, the amount of computation is reduced greatly.

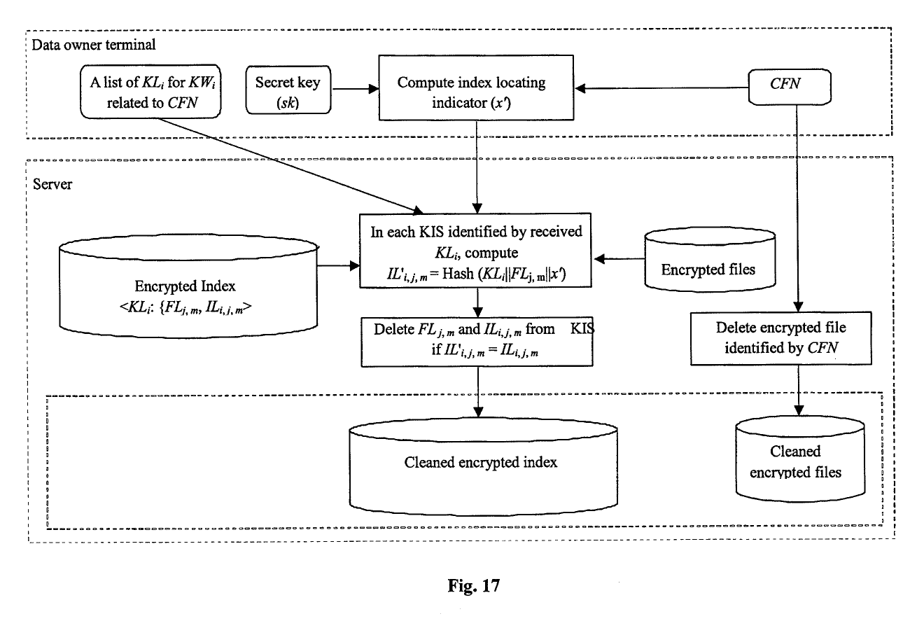

The data flow of the update of the encrypted index of this example is schematically illustrated in FIG. 17.

The above is an example of removing a file from the index. According to the invention, the encrypted index may be also easily updated in the case of adding one or more files later. For example, if the data owner adds an additional encrypted file to the storage service some time after the encrypted index has been established, the data owner terminal may simply compute the KIS locators and the file locators (accompanied with or without index locators) in association with the newly added file in the same manner as described above, and transmit them to the server. At the server, the index search unit 402 locates the KISes corresponding to the received KIS locators, and the index update unit 801 updates the encrypted index by simply adding the received file locators (accompanied with or without index locators) in the corresponding KISes. Thus, the information of the added file is incorporated in the updated index.

### [Fine-Grained Authorization]

It is described in the above exemplary embodiments that each pair of file locator generation and decryption keys are generated in connection with a privacy level and independent of any particular keyword. There is a concern that if a searcher issued with a file locator decryption key obtains any KIS locator that is never issued to him/her by the data owner, that searcher will still able to perform search by this KIS locator and decrypt file locators in the corresponding KIS.

To enhance the control of authorization, each pair of file locator generation and decryption keys may be generated in connection with both a privacy level and a particular keyword according to one embodiment of the invention. For example, the file locator generation and decryption keys in connection with a keyword KWᵢ and the privacy level m may be generated as follow:

EKey_{i, m}=DKey_{i,m}=Hash(MEK∥KWᵢ∥m) (Equation 7)

or generated by other algorithm mapping at least a combination of a corresponding keyword and a key to a unique value. With such extended file locator generation and decryption keys, a fine-grained authorization control is provided based on not only the privacy levels but also the keywords.

In accordance with such embodiment, the file locators of each file is generated in the indexing phase by encrypting file acquisition information with one or more extended file locator generation keys each related to a keyword associated with the file and a privacy level at which the file is revealable.

Assuming that the file acquisition information of a file FILEⱼ takes form of CFNⱼ∥K_{filej}, a particular algorithm for calculating the file locator is given below in comparison with equation 3 described above. That is, for a keyword KWᵢ associated with a file FILEⱼ and a privacy level m at which the file FILEⱼ is revealable, a file locator FL_{i, j, m} for FILEⱼ is generated as follow

FL_{i,j, m}=E(EKey_{i,m}, CFNⱼ∥K_{filej}) (Equation 8)

In accordance with such embodiment, each KIS of a keyword comprises all file locators generated with the extended file locator generation keys related to that keyword. That is to say, among all file locators of a file, only those generated with the extended file locator generation keys related to a specific keyword are put into the KIS of that keyword, and those generated with the extended file locator generation keys related to any other keyword will not. This ensures that any one cannot correctly decrypt the file locators in a KIS of a keyword if he/she does not possess a correct extended file locator decryption key related to that keyword. The other processes are the same as those described in the above embodiments.

In the searching phase, if the data owner wants to enable a searcher to search on a keyword, the data owner issues to the searcher the KIS locator of the keyword as well as the corresponding extended file locator decryption key of suitable privacy level in a secure manner. The use of the extended file locator decryption key by the searcher is the same as that of the file locator decryption key described in the above embodiments.

In accordance with this embodiment, each extended file locator decryption key is kept secret at respective searcher and will not revealed to the server. So, even if a KIS locator(s) is revealed to other ones, he/she cannot decrypt any file locators in the corresponding KIS with any file locator decryption key related to other keyword.

The other features of the invention such as confirmable decryption, virtual deletion, locating and updating can be similarly applied in this embodiment. The processes are basically the same except for that the file locator generation and decryption keys are replaced with the extended file locator generation and decryption keys.

It is notable that the invention is also applicable in the case that there is no need to differentiate privacy levels. In such case, file locator generation and decryption keys may be generated in connection with different keywords. For example, the file locator generation and decryption keys are generated as follow:

EKeyᵢ=DKeyᵢ=Hash(MEK∥KWᵢ) (Equation 9)

The processes of indexing, searching and updating are similar to those described above. The description thereof is not repeated here since the particular processes may be conceived by assuming there is only one privacy level.

### [Chained Authorization]

In the above illustrative embodiments, file locator generation and decryption keys of various privacy levels are generated independently with different parameters, and have no computational relation with each other.

In practice, it is possible that there is domination relation between different privacy levels, that is, a higher privacy level dominate any lower privacy level. In other words, a search at any privacy level is enabled to search on files dominated at any privacy level lower than his/her privacy level, and files dominated at his/her privacy level but not dominated at other lower privacy levels. For example, the data owner Bob categorizes the searchers who perform search on his files into different levels according to different relations. For example, family members have the highest privacy level (Level 1), close friends have a middle privacy level (Level 2), and common friends have a lowest privacy level (Level 3). Meanwhile, the ability of search on the files follows a rule that all the files dominated at a lower privacy level are also dominated at any higher privacy level. That is, all the files searchable by the common friends could be searched by the close friends and the family members, while all the files searchable by the close friends could be searched by the the family members.

In the invention, chained authorization is employed for such situation so as to make the authorization and management more simple and efficiently. One embodiment in which the chained authorization is applied according to the invention is described below.

It is assumed that there are n privacy levels, where the highest privacy is level 1, and privacy level m dominates any other lower privacy levels (privacy levels m+1, . . . , n), where m is a nature number less than n.

According to this embodiment, in setting file locator generation and decryption keys in the indexing phase, the data owner firstly sets the file locator generation and decryption keys for the highest privacy level by using hash function. For example, the file locator generation key EKey₁ and the file locator decryption key DKey₁ of the highest privacy level are generated as follow:

EKey₁=DKey₁=H¹(z) (Equation 10)

where H¹(z) denotes one time hash operation (Hash(z)), and z is an arbitrary string, for example, MEK, a combination of MEK and an arbitrary number, MEK∥KWᵢ, and so on. Preferably, z is a string that is easily remembered or retrieved by the data owner.

Then, the file locator generation and decryption keys of other privacy levels are generated in a manner of hash chain based on EKKey₁ and DKey₁. In particular, the file locator generation key EKeyₘ and the file locator decryption key DKeyₘ of the privacy level m are generated as follow:

EKeyₘ=DKeyₘ=H^{m}(z) (Equation 11)

$$( \underbrace{Hash ( Hash … Hash}_{m} ( z ) … ) ) .$$

where H^{m} (z) denotes m times hash operations

That is to say, the file locator generation key EKeyₘ and the file locator decryption key DKeyₘ of the privacy level m can be generated by the following recursive formula:

EKeyₘ=DKeyₘ=Hash(EKeyₘ₋₁)=Hash(DKeyₘ₋₁) (Equation 12)

The above calculation is performed by, for example, the encryption/decryption setting unit of the data owner terminal.

When authorizing, the data owner issues the file locator decryption keys of different privacy levels to the searchers at the respective level. The other processes are similar to those in the above embodiments.

It can be seen that a searcher at a privacy level m, who is issued with DKeyₘ, is able to figure out the file locator decryption key of any lower privacy level with ease (for example, by the file locator decryption unit of the searcher terminal) according to the hash algorithm that is known or published by the data owner, so as able to decrypt file locators at any lower privacy level. Because of one-way property of hash function, a searcher at a privacy level m cannot figure out the file locator decryption key of a higher privacy level, and thus a one-way chained authorization is ensured.

With the chained authorization of the above embodiment, the searchers at any privacy level can derive file locator decryption keys of any lower privacy level by computation so as to obtain capabilities of lower privacy levels, and thus a simple and convenient chained authorization is realized.

The method of chained authorization applicable in the invention is not limited to the above-mentioned hash chain algorithm, but can be any one-way authorization technology. For example, Forward Key Rotation (FKR) technology proposed by Mahesh Kallahalla, etc. in “Plustus: Scalable secure file sharing on untrusted storage”, in the Proceedings of the 2nd Conference on File and Storage Technologies (FAST'03), pp. 29-42 (31 Mar.-2 Apr. 2003, San Francisco, Calif.), published by USENIX, Berkeley, Calif., may be used. Another embodiment of the invention where such technology is applied.

It is assumed that e₀ is a public key of the data owner, and d₀ is a private key of the data owner. The data owner publishes the public key e₀ and keeps d₀ secret.

In setting the file locator generation and decryption keys in the indexing phase, the data owner selects an arbitrary integer k₀∈ [symbol] ₚ* and sets the file locator generation key EKeyₙ and the file locator encryption key DKeyₙ for the lowest privacy level n as follows:

EKeyₘ=DKeyₙ=k₀^{d}^{₀} (Equation 13)

The file locator generation and decryption keys of other privacy level m (m is a nature number less than n) is computed according to the following recursive formula:

EKeyₘ=DKeyₘ=(EKeyₘ₊₁)^{d}^{₀}=(DKeyₘ₊₁)^{d}^{₀} (Equation 14)

The above calculation is performed by, for example, the encryption/decryption setting unit of the data owner terminal.

When authorizing, the data owner issues the file locator decryption keys of different privacy levels to the searchers at the respective level. A searcher at a privacy level m, who is issued with DKeyₘ, is able to figure out the file locator decryption keys of any other lower privacy levels with ease according to the public key e₀ published by the data owner by the following recursive formula:

Dkeyₗ₊₁=(DKey₁)^{e}^{₀}, l=m, . . . , n−1 (Equation 15)

The above calculation is performed by, for example, the file locator decryption unit of the searcher terminal.

On the other hand, the search at the privacy level m cannot figure out the file locator decryption key of any higher privacy level. Thus, it also realizes a one-way chained authorization.

### [Alternatives]

Some particular embodiments according to the invention have been described above with reference to the drawings. However, the invention is not intended to be limited by any particular configurations and processes described in the above embodiments. Those skilled in the art may conceive of various alternatives, changes or modifications of the above-mentioned configurations, algorithms, operations and processes within the scope of the spirit of the invention.

For example, it is described in the above exemplary embodiments that each keyword has one KIS in the encrypted inverted index, and the KIS locator of each KIS is generated as uniquely corresponding to a keyword. However, the index may be also generated such that each KIS corresponds to not only a keyword, but also a privacy level (i.e., a file locator generation or decryption key). That is, files of the same privacy level and associated with the same keyword are indexed in one KIS, and files of different privacy levels are indexed in different KISes irrespective of whether these files are associated with the same keyword. In another words, each KIS corresponds to only one file locator generation (or decryption) key and one keyword. In such case, the KIS locator KL_{i,m} of a KIS corresponding to a keyword KWᵢ and a file locator generation key EKeyₘ (or file locator decryption key DKeyₘ)of privacy level m may be generated as follow:

KL_{i,m}=E(EKeyₘ, KWᵢ) (Equation 16)

or

KL_{i,m}=E(DKeyₘ, KWᵢ) (Equation 17)

The invention is never limited by the particular configurations and processes shown in the drawings. The examples embodying various aspects of the invention as described above may be combined according to particular application. For example, the encrypted index may comprise both the flag for confirming correctness of decryption and index locators for locating file locaters, and the data owner terminal, the server and the searcher terminal comprise corresponding components of the two aspects.

In addition, the order of the processes described above may be altered reasonably. For example, the order of steps S201 and S202 shown in FIG. 4 may be reversed, or these steps may be performed concurrently.

The so called “file” as used in this description should be interpreted as a broad concept, and it includes but not limits to, for example, text file, video/audio file, pictures/charts, and any other data or information.

As exemplary configurations of the data owner terminal, the searcher terminal and the server, some units coupled together have been shown in the drawing. These units can be coupled with a bus or any other signal lines, or by any wireless connection, to transfer signals therebetween. However, the components included in each device are not limited to those units described, and the particular configuration may be modified or changed. Each device may further comprise other units, such as a display unit for displaying information to the operator of the device, an input unit for receiving the input of the operator, a controller for controlling the operation of each unit, any necessary storage means, etc. They are not described in detail since such components are known in the art, and a person skilled in the art would easily consider adding them to the devices described above. In addition, although the described units are shown in separate blocks in the drawings, any of them may be combined with the others as one component, or be divided into several components. For example, the KIS locator generation unit, the file locator generation unit and index forming unit shown in FIG. 3 may be combined together as an index generation unit. Alternatively, the encryption/decryption setting unit described above may be divided into a unit for selecting keys for encryption/decryption and a unit for selecting other security parameters.

Further, data owner terminal, searcher terminal and the server are described and shown as separate device in the above examples, which may be positioned remotely each other in a communication network. However, they can be combined as one device for enhanced functionality. For example, the data owner terminal and the searcher terminal could be combined to create a new device that is data owner terminal in some cases while capable of performing search as a searcher terminal in some other cases. For another example, the server and the data owner terminal or the searcher terminal could be combined if it acts these two roles in an application. Also, a device may be created to act as data owner terminal, searcher terminal and server in different transactions.

The communication network as described above may be any kind of network including any kind of telecommunication network or computer network. It can also comprise any internal data transfer mechanism, for example, a data bus or hub when the data owner terminal, the searcher terminal and the server are implemented as parts of a single device.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine readable medium or transmitted by a data signal embodied in a carrier wave over a transmission medium or communication link. The “machine readable medium” may include any medium that can store or transfer information. Examples of a machine readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The code segments may be downloaded via computer networks such as the Internet, Intranet, etc.

The invention may be embodied in other specific forms without departing from the spirit or essential characteristics thereof. For example, the algorithms described in the specific embodiment can be modified as long as the characteristics do not depart from the basic spirit of the invention. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method for searchable encryption, comprising:
setting one or more file locator generation keys;
generating one or more keyword item set locators by mapping a string containing at least a keyword to a unique value;
generating one or more file locators by encrypting file acquisition information of each of a plurality of files with at least one file locator generation key; and
forming an encrypted index by one or more keyword item sets each being identified by a keyword item set locator and containing at least one or more file locators of the files associated with the corresponding keyword.

2. The method according to claim 1, further comprising:
setting a file encryption key for each file; and
encrypting each file with a corresponding file encryption key.

3. The method according to claim 1, wherein the file acquisition information comprises at least an encrypted resource identifier and a file decryption key of the file.

4. The method according to claim 3, wherein the file acquisition information further comprises a flag for confirmable decryption.

5. The method according to claim 1, wherein each file locator in a key item set is accompanied by an index locator, and the method further comprises:
generating an index locating indicator for each file by mapping a string containing at least an encrypted resource identifier of the file to an unique value; and
generating an index locator for each file locator in a key item set by mapping a string containing at least the file locator, the corresponding keyword item set locator and the index locating indicator of the file to a unique value.

6. The method according to claim 5, wherein the index locating indicator is generated as a hash value of a string containing at least the encrypted resource identifier and a secret key.

7. The method according to claim 1, wherein the keyword item set locator is generated as a hash value of a string containing at least the corresponding keyword and a master encryption key.

8. The method according to claim 1, wherein the keyword item set locator is generated by encrypting the corresponding keyword with a file locator generation key.

9. The method according to claim 1, wherein the one or more file locator generation keys are set in accordance with one or more privacy levels.

10. The method according to claim 9, wherein each file locator generation key is a hash value of a string containing at least a master encryption key and a value indicating the privacy level.

11. The method according to claim 9, wherein the file locator generation key of each privacy level is a hash value of the file locator generation key of a preceding higher privacy level.

12. The method according to claim 9, wherein the file locator generation key of each privacy level is d₀ power of the file locator generation key of a preceding lower privacy level, where d₀ is a privacy key.

13. The method according to claim 1, wherein each file locator generation key is a hash value of a string containing at least a keyword and a master encryption key.

14. An apparatus for searchable encryption, comprising:
an encryption/decryption setting unit configured to set one or more file locator generation keys;
a keyword item set locator generation unit configured to generate one or more keyword item set locators by mapping a string containing at least a keyword to a unique value; and
a file locator generation unit configured to generate one or more file locators by encrypting file acquisition information of each of a plurality of files with at least one file locator generation key; and
an index forming unit configured to form an encrypted index by one or more keyword item sets each being identified by a keyword item set locator and containing at least one or more file locators of the files associated with the corresponding keyword.

15. The apparatus according to claim 14, wherein the encryption/decryption setting unit is further configured to set a file encryption key for each of the plurality of files, and the apparatus further comprises a file encryption unit configured to encrypt each file with a corresponding file encryption key.

16. The apparatus according to claim 14, wherein the file acquisition information comprises at least an encrypted resource identifier and a file decryption key of the file.

17. The apparatus according to claim 16, wherein the file acquisition information further comprises a flag for confirmable decryption.

18. The apparatus according to claim 14, further comprising:
an index locating indicator generation unit configured to generate an index locating indicator for each file by mapping a string containing at least an encrypted resource identifier of the file to an unique value; and
an index locator generation unit configured to generate an index locator for each file locator in a key item set by mapping a string containing at least the file locator, the corresponding keyword item set locator and the index locating indicator of the file to a unique value,
wherein the index forming unit forms such encrypted index that each file locator in a key item set is accompanied by an associated index locator.

19. The apparatus according to claim 16, wherein the index locating indicator generation unit is configured to generate a hash value of a string containing at least the encrypted resource identifier and a secret key as the index locating indicator.

20. The apparatus according to claim 14, wherein the keyword item set locator generation unit is configured to generate a hash value of a string containing at least the corresponding keyword and a master encryption key as the keyword item set locator.

21. The apparatus according to claim 14, wherein the keyword item set locator generation unit is configured to generate the keyword item set locator by encrypting the corresponding keyword with a file locator generation key.

22. The apparatus according to claim 14, wherein the encryption/decryption setting unit is configure to set the one or more file locator generation keys in accordance with one or more privacy levels.

23. The apparatus according to claim 22, wherein the encryption/decryption setting unit is configure to set a hash value of a string containing at least a master encryption key and a value indicating the privacy level as the file locator generation key.

24. The apparatus according to claim 22, wherein the encryption/decryption setting unit is configured to set the file locator generation key of each privacy level to a hash value of the file locator generation key of a preceding higher privacy level.

25. The apparatus according to claim 22, wherein the encryption/decryption setting unit is configured to set the file locator generation key of each privacy level to d₀ power of the file locator generation key of a preceding lower privacy level, where d₀ is a privacy key.

26. The apparatus according to claim 14, wherein the encryption/decryption setting unit is configured to set a hash value of a string containing at least a keyword and a master encryption key as the file locator generation key.

27. A method used in encrypted file search, comprising:
storing an encrypted index comprising one or more keyword item sets, each keyword item set being identified by a keyword item set locator and containing at least one or more file locators each accompanied by an index locator;
receiving an index locating indicator; and
deleting a file locator from a keyword item set if the index locator accompanying the file locator equals to a value calculated by mapping a string containing at least the file locator, the keyword item set locator identifying the keyword item set and the received index locating indicator.

28. The method according to claim 27, further comprising:
receiving one or more keyword item set locators; and
searching for one or more keyword item set identified by the received one or more keyword item set locators,
wherein the deleting is performed within said one or more keyword item set.

29. The method according to claim 27, further comprising:
receiving a keyword item set locator;
searching for a keyword item set identified by the received keyword item set locator;
outputting file locators contained in said keyword item set;
receiving a set of encrypted resource identifiers; and
outputting encrypted files identified by encrypted resource identifiers which match the received encrypted resource identifiers.

30. The method according to claim 29, further comprising filtering out encrypted resource identifiers of encrypted files to be excluded in search from the set of encrypted resource identifiers after receiving the set of encrypted resource identifiers.

31. An apparatus used in encrypted file search, comprising:
a storage unit configured to store an encrypted index comprising one or more keyword item sets, each keyword item set being identified by a keyword item set locator and containing at least one or more file locators each accompanied by an index locator; and
an index updating unit configured to delete a file locator from a keyword item set if the index locator accompanying the file locator equals to a value calculated by mapping a string containing at least the file locator, the keyword item set locator identifying the keyword item set, and a received index locating indicator.

32. The apparatus according to claim 31, further comprising:
an index search unit configured to search for a keyword item set identified by a keyword item set locator in the encrypted index.

33. The apparatus according to claim 31, further comprising:
a file search unit configured to search for an encrypted files identified by an encrypted resource identifier.

34. The apparatus according to claim 33, further comprising:
a filter unit configured to filter out encrypted resource identifiers of files to be excluded in search from a received set of encrypted resource identifiers.

35. A method for encrypted file search, comprising:
receiving a keyword item set locator and a file locator decryption key;
retrieving one or more file locators with the keyword item set locator;
decrypting each file locator with the file locator decryption key to derive one or more encrypted resource identifiers and corresponding file decryption keys;
retrieving one or more encrypted files identified by the one or more encrypted resource identifier; and
decrypting each encrypted file with the corresponding file decryption key.

36. The method according to claim 35, further comprising:
receiving a flag; and
confirming decryption of each file locator by comparing the received flag with a flag derived from the decryption of the file locator.

37. The method according to claim 35, further comprising:
computing a hash value of the file locator decryption key to obtain the file locator decryption key of a lower privacy level.

38. The method according to claim 35, further comprising:
computing e₀ power of the file locator decryption key to obtain the file locator decryption key of a lower privacy level, where e₀ is a public key.

39. An apparatus for encrypted file search, comprising:
a search request unit configured to generate a search request containing at least a keyword item set locator;
a file locator decryption unit configured to decrypt one or more file locators with a file locator decryption key to derive one or more encrypted resource identifiers and corresponding file decryption keys;
a file acquisition unit configured to retrieve one or more encrypted files identified by the one or more encrypted resource identifier; and
a file decryption unit configured to decrypt each encrypted file with the corresponding file decryption key.

40. The apparatus according to claim 39, wherein the file locator decryption unit is further configured to confirm decryption of each file locator by comparing a received flag with a flag derived from the decryption of the file locator.

41. The apparatus according to claim 39, wherein the file locator decryption unit is further configured to compute a hash value of the file locator decryption key to obtain the file locator decryption key of a lower privacy level.

42. The apparatus according to claim 39, wherein the file locator decryption unit is further configured to compute e₀ power of the file locator decryption key to obtain the file locator decryption key of a lower privacy level, where e₀ is a public key.
